(19) United States
(12) Patent Application Publication
(10) Pub. No.: US 2016/0036129 A1
(43) Pub. Date: Feb. 4, 2016

(54) PLANAR INVERTED-F ANTENNA

(71) Applicant: FOXCONN INTERCONNECT TECHNOLOGY LIMITED, Grand Cayman (KY)

(72) Inventors: TZU-YAO HWANG, New Taipei (TW); LUNG-SHENG TAI, New Taipei (TW)

(21) Appl. No.: 14/810,725

(22) Filed: Jul. 28, 2015

(30) Foreign Application Priority Data
Jul. 30, 2014 (TW) 103213468

(51) Int. Cl. H01Q 9/04; H01Q 1/48

(52) U.S. Cl. CPC H01Q 9/045; H01Q 1/48

(57) ABSTRACT

A planar inverted-F antenna includes an antenna body including a grounding portion, a first and a second radiating arm extending in a lengthwise direction substantially, a coaxial cable and a metal foil attached the grounding portion. The first radiating arm and the second radiating arm extend in opposite directions from a joint point thereof, the joint point and the grounding portion connect with each other by a connecting portion. A first slot is defined between the first radiating arm and the grounding arm, a second slot is defined between the second radiating arm and the grounding portion. A coaxial cable includes a core soldered to the joint point and a shielding layer soldered to the grounding portion. The metal foil covers a most portion of the grounding portion, thereby exposes a first end of the grounding portion near to the first radiating arm to an exterior.

### BACKGROUND OF THE INVENTION

1. Field of the Invention

The present disclosure relates to a planar inverted-F antenna.

2. Description of Related Art

Miniaturization is a trend for portable electronic devices. Thus, components inner the portable electronic devices become thinner and smaller. Antenna, a necessary component in wireless communicating device, is manufactured to be smaller and lower. The space between the antenna and other components become smaller and smaller. Planar Inverted-F Antenna (PIFA) is a type of often-used antenna inner electronic devices. A typical PIFA always comprises a feed point and two radiating portions extending apart from each other from the feed point for working at different frequency bands. However, as the space between the PIFA and the other components is very small, the other components have negative impacts on the antenna, so that the antenna has a bad performance and fails to cover a broader band. Moreover, manufactures send the antennas a qualifications lab to make a performance test, which will waste cost and time.

In view of the above, an improved antenna is desired to overcome the problems mentioned above.

### SUMMARY OF THE INVENTION

Accordingly, an object of the present disclosure is to provide a planar inverted-F antenna.

According to one aspect of the present disclosure, a planar inverted-F antenna comprises an antenna body comprises a grounding portion, a first radiating arm and a second radiating arm extending in a lengthwise direction substantially, and a coaxial cable and a metal foil attached the grounding portion. The first radiating arm and the second radiating arm extend in opposite directions from a joint point thereof, the joint point and the grounding portion connect with each other by a connecting portion. A first slot is defined between the first radiating arm and the grounding arm, a second slot is defined between the second radiating arm and the grounding portion. A coaxial cable comprises a core soldered to the joint point and a shielding layer soldered to the grounding portion. The metal foil covers a most portion of the grounding portion, thereby exposes a first end of the grounding portion near to the first radiating arm to an exterior.

Other objects, advantages and novel features of the disclosure will become more apparent from the following detailed description when taken in conjunction with the accompanying drawings, in which:

### BRIEF DESCRIPTION OF THE DRAWINGS

FIG. 1 is a front elevational view of a planar inverted-F antenna in accordance with a preferred embodiment of the present disclosure;

FIG. 2 is a front exploded perspective view of the antenna shown in FIG. 1;

FIG. 3 is a further exploded perspective view of the antenna shown in FIG. 2; and

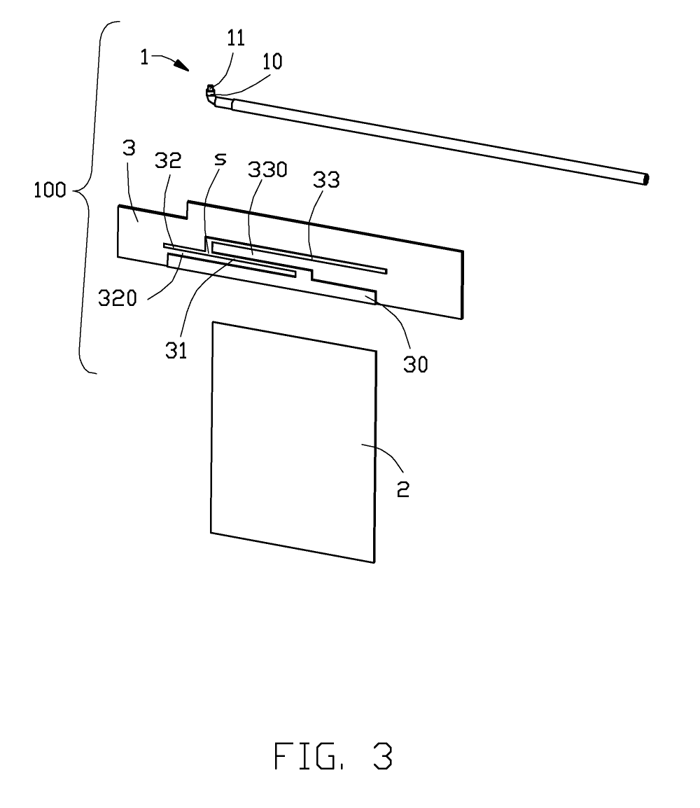

FIG. 4 is a graph showing a voltage standing wave ratio (VSWR) of the antenna of FIG. 1.

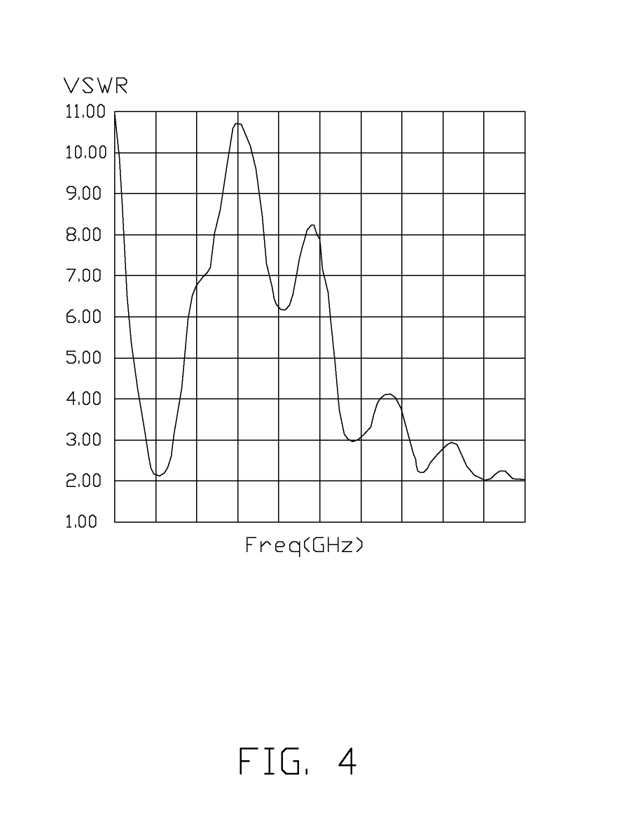

### DETAILED DESCRIPTION OF THE INVENTION

Reference will now be made to the drawings to describe a preferred embodiment of the present disclosure in detail.

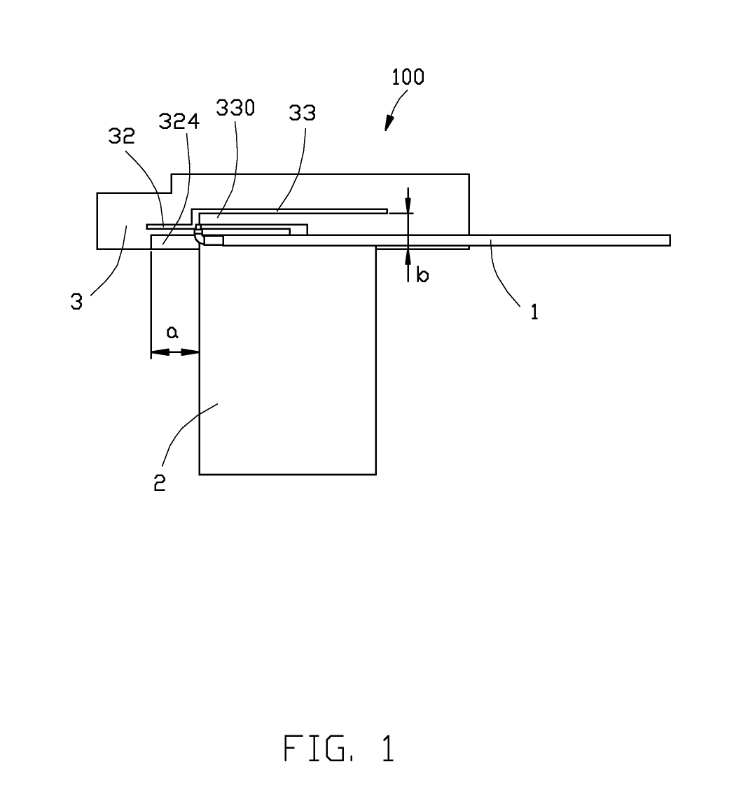

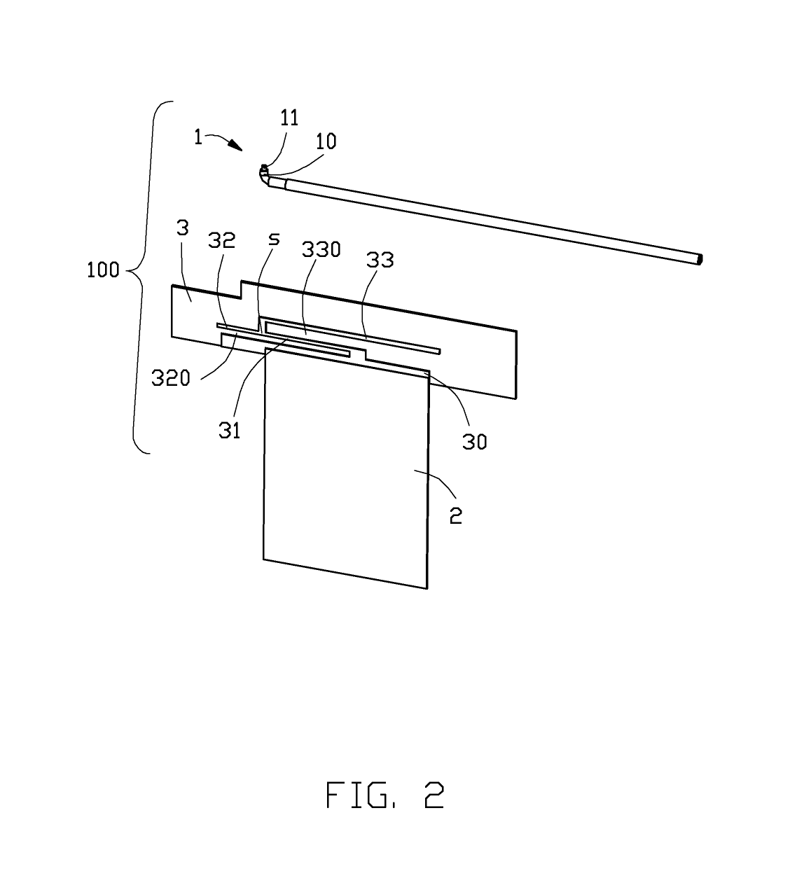

Referring to FIG. 1 and FIG. 2, a planar inverted-F antenna 100 in accordance with the preferred embodiment of the present disclosure, comprises an antenna body 3 extending in a lengthwise direction, a metal foil 2 and a coaxial cable 1 connecting with the antenna body 3. The antenna body 3 comprises a grounding portion 30 extending in the lengthwise direction and a connecting portion 31 extending from the grounding portion 30. A first radiating arm 33 and a second radiating arm 33 extend in opposite directions from a same lengthwise end S of the connecting portion 31. The first radiating arm 32 and a second radiating arm 33 extend in the lengthwise direction substantially, and the connecting portion 31 is parallel to the grounding portion 30.

A first slot 320 is defined between the first radiating arm 32 and the grounding portion 30 and a second slot 330 is defined between the second radiating arm 33 and the grounding portion 30. The width of the first slot 320 perpendicular to the lengthwise direction equals to 0.68 mm in a vertical direction. The second slot 330 has a larger width than the first slot in the vertical direction. Notably, the second slot 330 defines two different vertical dimensions along the lengthwise direction, and both two different vertical dimensions/widths are larger than the width of the first slot 320. The first radiating arm 32 works on a higher frequency band 5 GHz, and the second radiating arm 33 works on a lower frequency band 2.4 GHz.

The coaxial cable 1 comprises a conductive core 11 soldered to said lengthwise end S, i. e. a joint point or a signal feeder point, and a shielding layer 10 soldered to the grounding portion 30. The feeder point is disposed at the joint of he first and the second radiating arm. The metal foil 2 is attached the grounding portion 30. Please notes, the metal foil 2 cover a most portion of the grounding portion 30, thereby exposing a first end 324 of the grounding portion near to the first radiating arm 30 to an exterior. An outmost edge of the metal foil 2 is aligned with a second end opposite to the first end 324 of the grounding portion. As best shown in FIG. 1, during qualified test, the metal foil can be re-attached to control the distance a to adjust the antenna efficiency of the good higher frequency band and the distance b is to adjust the antenna efficiency of the lower frequency band.

While preferred embodiment in accordance with the present disclosure has been shown and described, equivalent modifications and changes known to persons skilled in the art according to the spirit of the present disclosure are considered within the scope of the present disclosure as defined in the appended claims.

What is claimed is:

1. A planar inverted-F antenna comprising:
an antenna body comprising a grounding portion, a first radiating arm and a second radiating arm extending in a lengthwise direction substantially, the first radiating arm and the second radiating arm extending in opposite directions from a joint point thereof, the joint point and the grounding portion connecting with each other by a connecting portion;
a first slot defined between the first radiating arm and the grounding arm a second slot defined between the second radiating arm and the grounding portion;
a coaxial cable comprising a core soldered to the joint point and a shielding layer soldered to the grounding portion;
a metal foil attached the grounding portion;
wherein the metal foil covers a most portion of the grounding portion, thereby exposes a first end of the grounding portion near to the first radiating arm to an exterior.

2. The planar inverted-F antenna as claimed in claim 1, wherein the first slot has a width between the first radiating arm and the grounding portion with 0.68 mm.

3. The planar inverted-F antenna as claimed in claim 2, wherein the second slot has a larger width than the first slot.

4. The planar inverted-F antenna as claimed in claim 1, wherein an outmost edge of the metal foil is aligned with a second end opposite to the first end of the grounding portion.

5. The planar inverted-F as claimed in claim 4, wherein the connecting portion is parallel to the grounding portion.

6. A planar inverted-F antenna comprising:
an antenna body comprising a lengthwise grounding portion having opposite first and second end along a lengthwise direction, a first radiating arm extending from a signal feeder point in a first orient of the lengthwise direction, and a second radiating arm extending from the signal feeder point in a second orient of the longwise direction opposite to the first orient, thereby a first slot being defined between the first radiating arm and the grounding portion and a second slot defined between the second radiating arm and the grounding portion;
a coaxial cable comprising a core soldered to the joint point and a shielding layer soldered to the grounding portion;
a metal foil attached to the grounding portion;
wherein the metal foil covers a most portion of the grounding portion and exposes a first end of the grounding portion near to the first radiating arm to an exterior.

7. An antenna comprising:
an antenna body including:
a grounding portion extending along a lengthwise direction;
an L-shaped connection portion extending from an upper edge of the grounding portion essentially along the lengthwise direction;
a first radiating arm extending from an end of the connecting portion along the same lengthwise direction with the connection portion;
an L-shaped second radiating arm extending from said end essentially along an opposite lengthwise direction;
the first radiating arm and the connecting portion being essentially located between the grounding portion and the second radiating arm in a vertical direction perpendicular to said lengthwise direction;
a metallic foil attached to the grounding portion extending in the vertical direction opposite to said connecting portion, said first radiating arm and said second radiating arm; and
a coaxial cable including an inner conductor mechanically and electrically connected around said end, and an outer conductor mechanically and electrically connected to the metallic foil; wherein
the metallic foil is essentially located under the second radiating arm, and a first distance along the lengthwise direction between an end of the grounding, which is located under the first radiating arm, and a side edge of the metallic foil, which is located under the second radiating arm and close to the end, determines a high frequency performance, while a second distance in the vertical direction between the second radiating arm and an upper edge of the metallic foil determines a lower frequency performance.

8. The antenna as claimed in claim 7, wherein a dimension of the metallic foil along said lengthwise direction is smaller than that of the grounding portion.

9. The antenna as claimed in claim 8, wherein the metallic foil is within a boundary of the grounding portion in said lengthwise direction.

10. The antenna as claimed in claim 7, wherein an end of the first radiating arm extends beyond said end of the grounding portion in said lengthwise direction.

11. The antenna as claimed in claim 7, wherein an end of the second radiating arm extends in said opposite lengthwise direction beyond another end of the grounding portion.

12. The antenna as claimed in claim 7, wherein a dimension of the first radiating arm is smaller than that of the connection portion in the lengthwise direction.

13. The antenna as claimed in claim 12, wherein a dimension of the connecting portion is smaller than that of the second radiating arm in the lengthwise direction.
